(19) United States
(12) Patent Application Publication
(10) Pub. No.: US 2008/0073822 A1
(43) Pub. Date: Mar. 27, 2008

(54) Angle corner clamp

(75) Inventor: Harry Wong, South Pasadena, CA (US)

Correspondence Address: PAUL WANG, 7141 PARAMOUNT BLVD., PICO RIVERA, CA, 90660-3769, US

(73) Assignee: Valtra, Inc.

(21) Appl. No.: 11/903,661

(22) Filed: Sep. 24, 2007

Related U.S. Application Data
(60) Provisional application No. 60/847,542, filed on Sep. 26, 2006.

(51) Int. Cl. B25B 1/24

(52) U.S. Cl. 269/41

(57) ABSTRACT

A clamping device utilizing the mechanism of conventional locking plier comprises a swiveled V-shape convex clamping jaw and a V-shape concave clamping jaw. The V-shape convex clamping jaw is pivoted to one end of a straight shank slidably mounted to the fixed arm of the clamping device. The V-shape concave clamping jaw comprising two flat clamping surfaces of various forms including but not limited to rectangular form is mounted to the movable arm of the clamping device. A crank handle is provided at the end of the fixed handle of the clamping device.

This application claims the priority of U.S. Provisional Patent Application Ser. No. 60/847,542 filed Sep. 26, 2006.

### REFERENCE

### U.S. Patent Documents

| | | |
|---|---|---|
| 4,134,578 | January 1979 | James R. Stanley |
| 4,305,575 | December 1981 | Dales L. Bardes |
| 4,483,059 | November 1984 | Timothy C. Dearman |
| 4,673,174 | June 1987 | William D. Tabbert |

### BACKGROUND OF THE INVENTION

1. Field of the Invention

The present invention relates to a class of locking pliers in general, and particularly to angle corner clamp with improved clamping jaws to hold two workpieces at right angle relationship. One of the clamping jaws of the present invention is slidable with lock and quick release mechanism to enable fast adjustment to suit workpieces of various thicknesses. A crank handle is provided at the end of the fixed handle of the present invention for easy and fine adjustment of the clamping operation and clamping force.

2. Description of the Related Art

A typical locking plier comprises a fixed handle, a fixed arm with clamping jaw, a movable handle, a movable arm attached with clamping jaw and a toggling linkage mechanism between the fixed handle and the movable handle. A variety of clamping jaws have been developed to serve different clamping applications. For example: floating V-shape and half-cylindrical jaws for clamping flat, cylindrical and angled workpieces used in Clamp, U.S. Pat. No. 4,134,578 invented by James R. Stanley; L-shape clamping jaws with nails for wood framing used in Toe-nailing Clamping Tool, U.S. Pat. No. 4,305,575 invented by Dale L. Bardes; adjustable V-shape jaws for holding cylindrical pipes used in Clamping and Spacing Tool, U.S. Pat. No. 4,483,059 invented by Timothy C. Dearman; and variable angle V-shape jaws for clamping flat workpieces at different angles used in Angle Clamping Tool, U.S. Pat. No. 4,673,174 invented by William D. Tabbert.

However, almost all of these prior arts are equipped with relatively small clamping surfaces. In order to hold the workpieces firmly, we need to apply a stronger clamping force on the workpieces. If the clamping surfaces are too small, even a very strong clamping force may not hold the workpieces firm enough as needed. The stronger clamping force may result in stronger clamping pressure and causes damage to the surface of the workpieces too. On the other hand, the small clamping jaws of most of the prior arts limit the variety of applications. Furthermore, most of the jaws of the prior arts are fixed in position, this lacks the ability to adjust the effective clamping gap easily and quickly to suit various thicknesses or sizes of the workpieces and lacks the flexibility to suit various applications.

It is the intention of the present invention to provide clamping jaws of larger clamping surfaces to hold workpieces firmly as needed but with smaller clamping pressure to minimize the damage to the surfaces of the workpieces. Another intention of the present invention is to provide larger clamping jaws to hold workpieces not only to form a right angle corner but mutually perpendicular in any form. Further intention of the present invention is to provide a convenient means to enable easy and quick adjustment of the clamping gap between the jaws to suit various thicknesses of the workpieces. Yet another intention of the present invention is to provide a crank handle for quick and easy setup of the tool and fine adjustment of the clamping force.

### SUMMARY OF THE INVENTION

The present invention comprises a fixed handle to which a L-shape fixed arm with V-shape convex clamping jaw and slidable straight shank is attached, a movable handle to which a L-shape movable arm with V-shape concave clamping jaw is pivotally mounted, a toggling linkage mechanism connected between the fixed handle and the movable handle, an adjustment screw inserted into the free end of the fixed handle, and a crank handle inserted to a hole at the free end of the adjustment screw. The fixed handle, the movable handle, the adjustment screw and the toggling linkage mechanism are similar in design as the conventional locking pliers. The principle of operations of these parts will not be discussed here again.

The L-shape fixed arm is equipped with a rectangular hole at the free end, and a straight metal shank is inserted through the rectangular hole so that it is free to slide upward and downward. At the upper end of the straight shank, a small pin is fixed to prevent the shank from falling through the rectangular hole. At the lower end of the straight shank, a V-shape convex clamping jaw is pivotally mounted so that it can be swiveled in one direction or in all directions. Along one edge of the straight shank, saw-teeth are provided for the adjustment and locking of the straight shank at various positions relative to the L-shape fixed arm. A lever linkage is pivoted to the body of the fixed arm to control the in and out of a spring loaded wedge shape plunger. When the lever is pressed, the wedge shape plunger is pulled away from one of the saw-teeth of the straight shank and the straight shank is free to slide up or down through the rectangular hole of the fixed arm. When the lever is released, the wedge shape plunger is pushed by the force of a loaded spring into one of the saw-teeth of the straight shank, hence the straight shank is locked in a fixed position along the rectangular hole of the fixed arm. The V-shape convex clamping jaw is made wider and longer so that larger clamping surfaces are available to increase the clamping force but reduce the clamping pressure on the workpieces. This will minimize the damage to the surfaces of the workpieces when clamping force is applied. The clamping surfaces on both sides of the V-shape convex clamping jaw are made to be at 90-degree spatial relationship. The free end of the movable arm is cylindrical in shape and equipped with a threaded hole. A V-shape concave clamping jaw can be fixed to the movable arm by a screw through the threaded hole. The V-shape concave clamping jaw is made wider and longer so that larger clamping surfaces are available to increase the clamping force but reduce the clamping pressure on the workpieces. Besides rectangular shape, the two clamping surfaces of the V-shape concave clamping jaw can be made to be any form to serve various clamping applications. The two clamping surfaces on both sides of the V-shape concave clamping jaw are made to be at 90 degree spatial relationship. With the V-shape convex clamping jaw and the V-shape concave clamping jaw, the present invention can be used to clamp two flat workpieces to form a right angle corner. With the wider and longer clamping surfaces of both the V-shape convex clamping jaw and the V-shape concave clamping jaw, the present invention can be used to clamp two workpieces perpendicular to each other in a form other than a right angle corner. Furthermore, with a special design of the two clamping surfaces of the V-shape concave clamping jaw other than rectangular shape, the present invention can be used to clamp two workpieces perpendicular to each other easily in unlimited forms.

To clamp workpieces of various thicknesses, a quick and easy adjustment of the present invention is possible by pressing the lever mechanism to release the straight shank and slide it up or down the rectangular hole at the free end of the fixed arm. Once the desired clamping gap is reached, release the lever mechanism and the straight shank is locked into place for secure clamping of the workpieces.

A crank handle is inserted to a hole made at the free end of the adjustment screw of the fixed handle for fine and quick adjustment of the clamping gap and clamping force desired on the workpieces.

### BRIEF DESCRIPTION OF THE DRAWINGS

FIG. 1 is a perspective view of the present invention;

FIG. 2 is a perspective view of the present invention clamping two workpieces forming a right angle corner;

FIG. 3 is a perspective view of the present invention clamping two workpieces perpendicular to each other;

FIG. 4 is a perspective view of one of the alternative design of the V-shape concave clamping jaw;

FIG. 5 is a perspective view of the present invention with the alternative design V-shape concave clamping jaw attached; and

FIG. 6 is a perspective view of the present invention (partly shown) clamping two workpieces perpendicular to each other using the alternative design V-shape concave clamping jaw.

### DETAILED DESCRIPTION OF THE INVENTION

With the help of the drawings and the detail description below, the features of the present invention will be apparent and fully understandable.

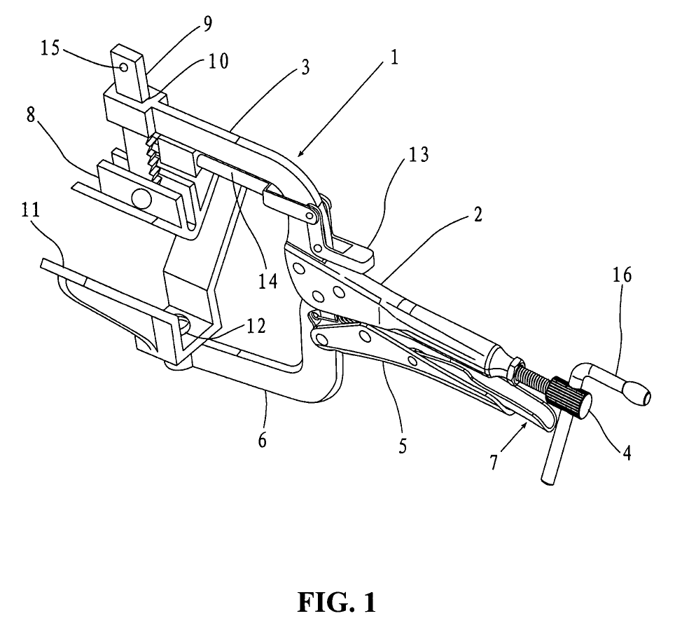

Referring to FIG. 1, the present invention 1 comprises a fixed handle 2 to which a L-shape fixed arm 3 is attached at one end and an adjustment screw 4 is inserted to the other end, a movable handle 5 to which a L-shape movable arm 6 is pivotally mounted, a toggling linkage mechanism 7 pivotally connected between the fixed handle 2 and the movable handle 5, a V-shape convex clamping jaw 8 pivotally mounted to a straight shank 9 which is inserted to a rectangular hole 10 at the free end of the fixed arm 3, a V-shape concave clamping jaw 11 mounted to the free end of the movable arm 6 with a screw 12, a crank handle 16 inserted to a hole at one end of the adjustment screw 4, and a lever linkage 13 pivotally mounted on the body of the fixed arm 3 for controlling the in and out of a spring loaded wedge shape plunger 14. The two clamping surfaces of the convex clamping jaw 8 are made to be at 90-degree spatial relationship. The two clamping surfaces of the concave clamping jaw 11 are made to be at 90-degree spatial relationship. The clamping surfaces of both the convex clamping jaw 8 and the concave clamping jaw 11 are made to be wider and longer to increase the clamping force on the workpieces with less clamping pressure. The convex clamping jaw 8 is mounted to the straight shank 9 through a pivot so that it can be swiveled in one direction or in all directions (the one direction design is shown in FIG. 1 to FIG. 6 here). This will assure that the clamping surfaces will contact fully on the surfaces of workpieces of various thicknesses. The straight shank 9 is free to slide up and down inside the rectangular hole 10 so that the clamping gap between the convex clamping jaw 8 and the concave clamping jaw 11 is adjustable to suit various thicknesses of the workpieces. At the top end of the straight shank 9, a small pin 15 is inserted and fixed to prevent the straight shank 9 from falling off the fixed arm 3. Along one edge of the body of the straight shank 9, saw-teeth are equipped to engage with the wedge shape plunger 14. Thus the straight shank 9 is locked in a position relative to the end of the fixed arm 3. When the lever linkage 13 is pressed, the wedge shape plunger 14 is pulled away from the saw-tooth and the straight shank 9 is released for sliding up or down the rectangular hole 10. This enables quick and easy adjustment of the effective clamping gap between the clamping jaws. Once the desired clamping gap is achieved, the lever linkage 13 is released, the wedge shape plunger is pushed by a loaded spring into a saw-tooth and the straight shank 9 is locked in position. Then the present invention 1 can be used for clamping workpieces. The crank handle 16 provides a quick and easy means to fine adjust the clamping gap and clamping force on the workpieces.

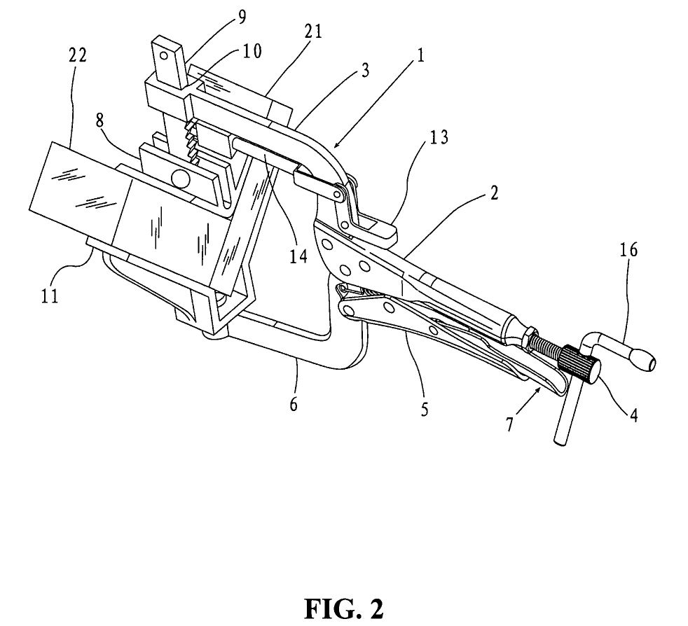

FIG. 2 shows two workpieces 21 and 22 which are clamped with the present invention 1 to form a right angle corner.

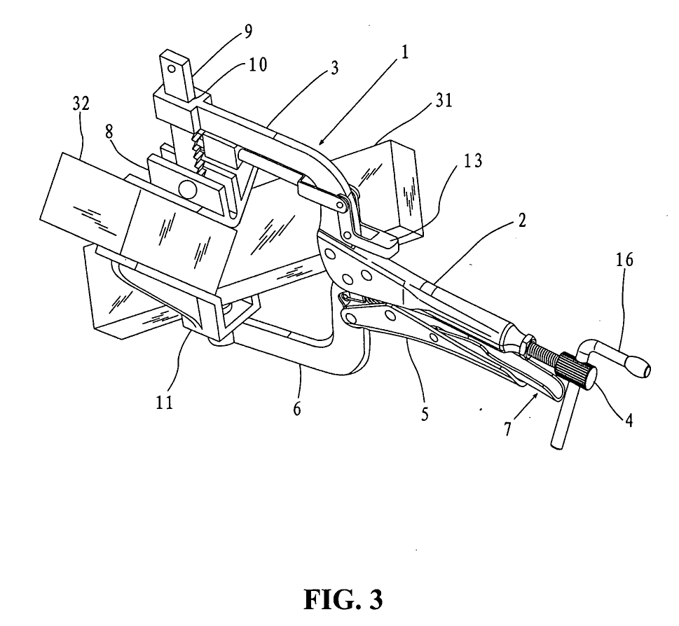

Besides forming a right angle corner, one workpiece 32 can be clamped perpendicular to the other workpiece 31 at certain angle between one of the edges of workpieces 31 and one of the edges of workpiece 32 with the use of one set of the present invention 1 as shown in FIG. 3.

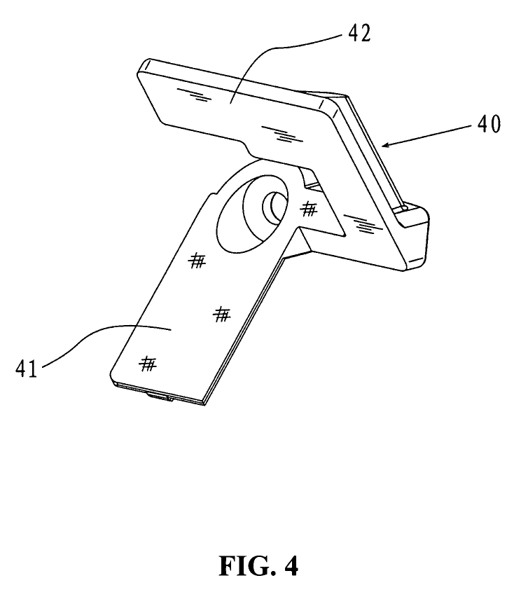

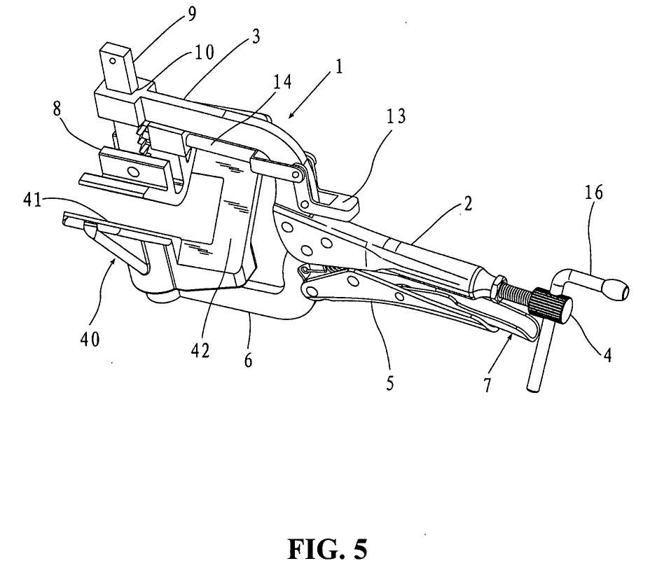

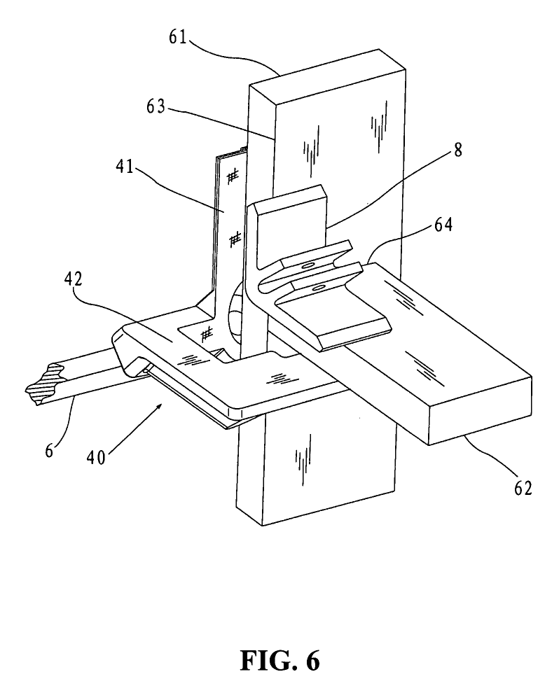

FIG. 4 shows one of the alternative designs of the V-shape concave clamping jaw 40. It comprises two flat clamping surfaces 41 and 42. Clamping surface 41 is in rectangular form and clamping surface 42 forms a J-shape. FIG. 5 shows the present invention with this alternative design V-shape concave clamping jaw 40 mounted on the movable arm 6. The application of this combination is shown in FIG. 6.

FIG. 6 shows the alternative design V-shape concave clamping jaw 40 mounted on the movable arm 6 (partially shown) working with the V-shape convex clamping jaw 8 mounted on the straight shank 9 (not shown). In this application, the present invention 1 is clamping two workpieces 61 and 62 where workpiece 62 is perpendicular to workpiece 61 with its edge 64 at right angle to the edge 63 of workpiece 61. This is not possible using the V-shape concave clamping jaw 11 as shown in FIG. 3. If the V-shape convex clamping jaw 8 can be swiveled in all directions, the application is not limited to the condition shown in FIG. 6 here. Workpiece 62 can be clamped perpendicular to workpiece 61 with its edge 64 at a broad range of angles to edge 63 as needed.

What I claim as my invention is:

1. An angle corner clamp having a fixed handle and a movable handle linked together by a toggling linkage mechanism similar to the design of a conventional locking plier comprising:
a L-shape fixed arm with one end riveted to a first end of said fixed handle and the other end equipped with a rectangular hole;
a L-shape movable arm with one end pivoted to one end of said movable handle and the other end equipped with a threaded hole;
a straight shank inserted into said rectangular hole of said L-shape fixed arm;
a lever linkage pivotally mounted on said L-shape fixed arm;
a V-shape convex clamping jaw pivotally mounted to one end of said straight shank;
a V-shape concave clamping jaw mounted on said L-shape movable arm with a screw through said threaded hole on said L-shape movable arm;
an adjustment screw fed into a second end of said fixed handle, said adjustment screw having a cylindrical head with a cylindrical hole made perpendicular to its axis; and
a crank handle inserted to said cylindrical hole of said cylindrical head of said adjustment screw.

2. The angle corner clamp according to claim 1, wherein said straight shank having saw-teeth along one of its edges is slidable through said rectangular hole of said fixed arm.

3. The angle corner clamp according to claim 1, wherein said lever linkage comprises a wedge shape plunger to be pushed in by a loaded spring or pulled out by finger to engage or disengage respectively with one of said saw-teeth.

4. The angle corner clamp according to claim 1, wherein said V-shape convex clamping jaw comprises two flat clamping surfaces at 90-degree spatial relationship.

5. The angle corner clamp according to claim 1, wherein said V-shape convex clamping jaw is made to be swiveled in one direction or in all directions.

6. The angle corner clamp according to claim 1, wherein said V-shape concave clamping jaw comprises two flat clamping surfaces at 90-degree spatial relationship.

7. The angle corner clamp according to claim 6, wherein said clamping surfaces of said V-shape concave clamping jaw comprise a plurality of design features in shape, including but not limited to rectangular, J-shape, etc.

8. The angle corner clamp according to claim 1, wherein said crank handle is L-shape.
